(19) United States
(12) Patent Application Publication
(10) Pub. No.: US 2003/0205100 A1
(43) Pub. Date: Nov. 6, 2003

(54) Park lock system

(76) Inventors: Michael C. Vermeersch, Saginaw, MI (US); Richard L. Kramer, Saginaw, MI (US); Larry W. Burr, Saginaw, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/426,113

(22) Filed: Apr. 29, 2003

Related U.S. Application Data
(60) Provisional application No. 60/377,496, filed on May 1, 2002.

(51) Int. Cl. B60K 20/00

(52) U.S. Cl. 74/473.32

(57) ABSTRACT

A park lock mechanism for a steering column of a vehicle has a key cylinder rotatable about an axis between off and on positions. A shift lever is movable between a park position and a non-park position and an inhibitor free from any mechanical cable attachment has a locked and unlocked position operably communicating with the key cylinder. When the key cylinder is in the off position, the inhibitor is operably maintained in the locked position to prevent movement of the shift lever from the park position. When the key cylinder is rotated to the on position, the inhibitor is moveable to the unlocked position in response to movement of the shift lever from the park position to the non-park position.

This application claims the benefit of U.S. Provisional Application 60/377,496, filed May 1, 2002.

### TECHNICAL FIELD

This application relates generally to steering columns, and more particularly to park lock systems for steering columns.

### BACKGROUND OF THE INVENTION

Many steering column assemblies today are equipped with park lock systems to prevent inadvertent or unintended shifting of a transmission out of a parked position. Typically, park lock systems incorporate a cable extending between a key cylinder and a shift lever of a steering column assembly. The cable is typically driven through rotation of the key cylinder, commonly performed while starting the vehicle, from a locked position to an unlocked position to operably allow the shift lever to be moved from its parked position to a non-park position. Typically, the cable has an inhibitor device attached at an end of the cable adjacent an end of the shift lever which is caused to move through movement of the cable.

Park lock systems utilizing cables typically have adjusters incorporated at a point over the length of the cable. The adjusters allow for fine tuning of the park lock system in assembly. Having to adjust the park lock system during assembly requires additional time, thus adding cost to the assembly process. Additionally, when the cables are mechanically connected to the key cylinder, the effort required to rotate the key cylinder in a normal starting sequence can be as a result of the friction between the cable and a cable sheath, which can lead to winding up or sticking of the cylinder, requiring the operator to manually rotate the key cylinder to its intended position. Otherwise, when the cable is mechanically attached to the shift lever, the effort to pivot the shift lever can be increased.

Such cables typically call for the assembly of connectors and/or inhibitors at the ends of the cables, which adds cost to the assembly of the column, and cost attributed to the numerous component parts as well as adding weight to the system. Therefore, although mechanical cable systems may be effective in many applications, those park lock systems incorporating such cables require additional time and response in manufacturing and assembling the system, require numerous component parts, require space for routing the cable through the assembly, and increase the effort of key cylinder rotation. It is an object of the present invention to overcome or minimize the foregoing limitations of the prior systems.

### SUMMARY OF THE INVENTION

A park lock mechanism for a steering column of a vehicle has a key cylinder rotatable about an axis between off and on positions. A shift lever is movable between a park position and a non-park position and an inhibitor free from any mechanical cable attachment has a locked and unlocked position operably communicating with the key cylinder. When the key cylinder is in the off position, the inhibitor is operably maintained in the locked position to prevent movement of the shift lever from the park position. When the key cylinder is rotated to the on position, the inhibitor is moveable to the unlocked position in response to movement of the shift lever from the park position to the non-park position.

One object of the invention is to provide a park lock system for a steering column that eliminates cables from the park lock system, thereby eliminating the associated time and cost incurred through the use of cables.

Another object of the invention is to eliminate the need for adjusters in park lock systems.

Another object of the invention is to reduce the effort required to rotate a key cylinder in a steering column assembly.

Another object of the invention is to reduce the number of associated component parts in park lock systems.

Another object of the invention is to provide a robust, reliable, easy to assemble, and low cost park lock system for steering column assemblies.

Other objects, features and advantages of the invention will become more apparent as this description proceeds.

### BRIEF DESCRIPTION OF THE DRAWINGS

The present invention will now be described, by way of example, with reference to the accompanying drawings, in which:

FIG. 1 is a side view of a vehicle having a steering column assembly incorporating a park lock mechanism constructed according to a presently preferred embodiment of the invention;

FIG. 2 is an enlarged partially cut away perspective view of the steering column assembly of FIG. 1;

FIG. 3 is a partial cross-sectional view of the steering column assembly of FIG. 1 taken generally along lines 3-3 of FIG. 2 showing the park lock mechanism in a locked position and the cylinder in the off position;

FIG. 4 is a view like FIG. 3 but showing the park lock mechanism in an unlocked position and the cylinder in the on position;

FIG. 5 is a fragmentary view shown partly in section taken generally along lines 5-5 in FIG. 3;

FIG. 6 is a fragmentary view shown partly in section taken along line 6-6 in FIG. 4;

FIG. 7 is a fragmentary sectional view like FIG. 3 but of an alternative embodiment of the invention in a locked position;

FIG. 8 is a view like FIG. 7, but in an unlocked position;

FIG. 9 is a perspective view of an alternate embodiment of a steering column assembly constructed according to a presently preferred embodiment of the invention;

FIG. 10 is a fragmentary view shown partly in section taken generally along lines 10-10 of FIG. 9 showing a shift lever in a park position;

FIG. 11 is a view like FIG. 10, but showing the shift lever in a non-parked position;

FIG. 12 is a fragmentary view shown partly in section taken generally along lines 12-12 of FIG. 10 shown in the park position;

FIG. 13 is a view like FIG. 12, but in the non-park position;

FIG. 14 is a partial sectional view taken generally along lines 1414 of FIG. 9 shown in the park position; and

FIG. 15 is a view like FIG. 14, but in the non-park position.

### DETAILED DESCRIPTION OF THE PREFERRED EMBODIMENTS

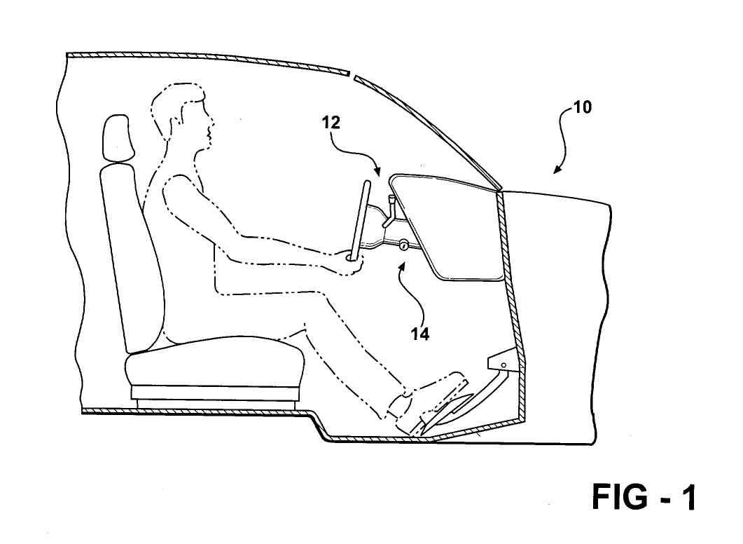

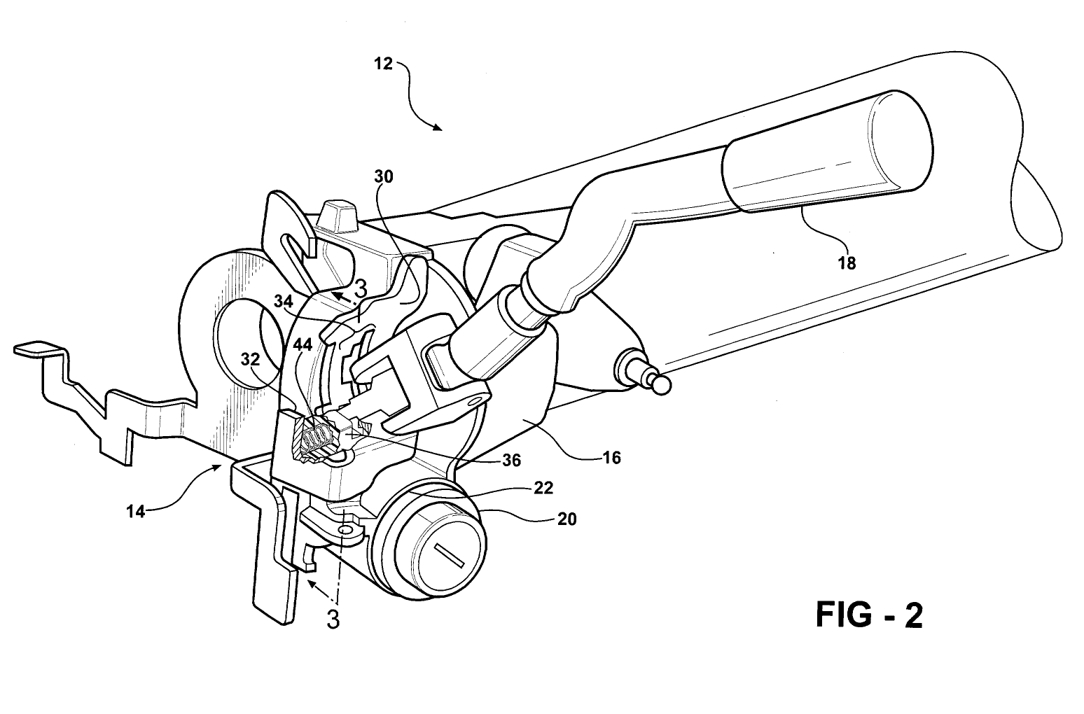

As shown in FIG. 1, a vehicle 10 has a steering column assembly 12 with a park lock mechanism constructed according to a presently preferred embodiment of the invention represented generally at 14. An enlarged perspective view of the steering column assembly 12 is shown in FIG. 2, wherein the steering column assembly 12 comprises a housing 16 pivotally supporting a shift lever 18 for movement between a park position and a non-park position. The housing 16 rotatably supports a key cylinder 20 for rotation between an “off” position and an “on” position. When the key cylinder 20 is in the “off” position, the park lock mechanism 14 prevents the shift lever 18 from moving out of the park position. Upon rotating the key cylinder 20 to the “on” position, the park lock mechanism 14 allows movement of the shift lever 18 from the park position to the non-park position. As such, the park lock mechanism 14 prevents inadvertent or unintended movement of the shift lever 18 from the park position to the non-park position.

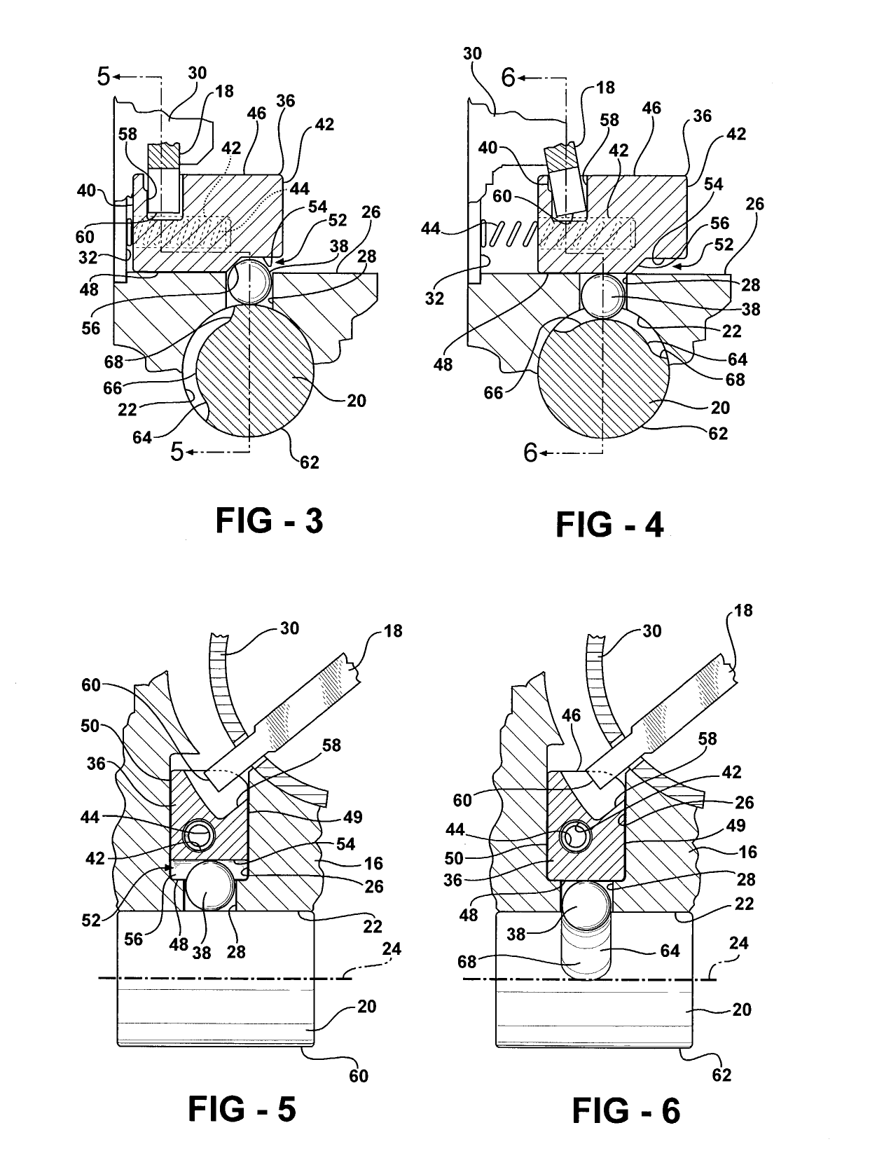

The housing 16 preferably has an opening 22 sized to rotatably receive the key cylinder 20. The opening 22 has an axis 24 corresponding to the axis of rotation of the key cylinder 20. As best shown in FIGS. 3-6, a channel 26 is generally offset and extends generally perpendicular relative to the opening 22 wherein a passage 28 extends between the channel 26 and the opening 22. The housing 16 mounts the shift lever 18 and also provides attachment of a shift lever gate 30. The shift lever gate 30 has an end wall surface 32 acting at least in part to maintain the park lock mechanism 14 within the channel 26. The shift lever gate 30 has detents 34 that provide guided movement of the shift lever 18 between the parked position and the non-parked positions.

As best shown in FIGS. 3-6, the park lock mechanism 14 preferrably comprises an inhibitor 36 and a barrier member 38. The inhibitor 36 is sized for slidable movement in response to pivotal movement of the shift lever 18 between a locked position and an unlocked position within the channel 26 of the housing 16. The inhibitor 36 has a pair of opposite ends 40, 41, with the end 40 preferably having a spring pocket 42 with a spring 44 disposed therein. The spring 44 preferably exerts a constant force bias on the end wall surface 32 of the shift lever gate 30 to bias the inhibitor 36 toward the unlocked position. As such, when the shift lever 18 is in the non-park position disengaged from the inhibitor 36 (FIGS. 4-6), the spring 44 maintains the inhibitor 36 in the unlocked position and maintains the inhibitor 36 in position to receive the shift lever 18.

The inhibitor has an upper surface 46 and a lower surface 48 with a pair of side walls 49, 50 extending therebetween. Preferably, the inhibitor 36 has a barrier pocket 52 extending inwardly from the lower surface 48 toward the upper surface 46. The barrier pocket 52 defines a recessed surface 54 and a shoulder 56, preferably inclined, extending between the recessed surface 54 and the lower surface 48.

When the shift lever 18 is in the park position, and the key cylinder 5 20 is in the off position (FIGS. 3 and 5), the barrier member 38 is received in the barrier pocket 52 of the inhibitor 36. If the shift lever 18 is biased toward the non-park position while the key cylinder 20 is in the “off” position, the barrier member 38 engages the shoulder 56 and the passage 28 to prevent movement of inhibitor 36 along the channel 26, and thus preventing movement of the shift lever 18 from the park position.

The inhibitor 36 preferably has a slot 58 extending into the upper surface 46 wherein a free end 60 of the shift lever 18 is received for mating engagement with the inhibitor 36. As the shift lever 18 moves from the park position (FIGS. 3 and 5) toward the non-park position (FIGS. 4 and 6), and vice versa, the free end 60 engages the slot 58 to slidably move the inhibitor 36 between the locked and unlocked positions.

The key cylinder 20 is preferably free from any mechanical cable attachment and has an outer surface 62 and a groove 64 extending inwardly to a base 66 for receiving the barrier member 38 at least in part. Preferably, an inclined surface or cam surface 68 is inclined between the base 66 and the outer surface 62.

Referring to FIGS. 4 and 6, when the shift lever 18 is positioned in a non-park position (e.g., such as positioned in the “drive” position during operation of the vehicle in which the system is installed), the movement of the key cylinder 20 is restricted to prevent the key cylinder 20 from being turned from the “on” position shown, to the off position (of FIGS. 3 and 5). Rotation of the key cylinder 20 toward the “off” position brings the cam surface 68 at the end of the groove 64 into engagement with the barrier member 38, causing the barrier member 38 to be cammed outwardly of the groove 64 by the ramping effect of the cam surface 68. However, the barrier member 38 confronts the overlying lower surface 48 of the inhibitor 36 and blocks such outward movement of the barrier member 38. Consequently, the key cylinder 20 is blocked against movement to the “off” position when the shift lever 18 is in other than the park position (i.e., in any non-park position).

Referring additionally to FIGS. 3 and 5, when the shift lever 18 is moved to the park position, the inhibitor 36 is caused to slide out of blocking relation with the barrier member 38, bringing the recessed surface 54 into position over the barrier member 38. In this position, the key cylinder 20 is able to be rotated from the “on” position of FIGS. 4 and 6 to the “off” position of FIGS. 3 and 5. As the cylinder 20 is rotated toward the “off” position, the cam surface 68 confronts the barrier member 38 and displaces the barrier member 38 outwardly of the groove 66 and into the recessed surface 54 and against the outer surface 62 of the cylinder 20, enabling the cam surface 68 of the cylinder 20 to be rotated past the barrier member 38 to the fully “off” position of FIGS. 3 and 5.

It will be appreciated that the positioning of the cylinder 20 in the “off” position (FIGS. 3 and 5) traps the inhibitor 36 in the park position, since the barrier member 38 is positioned within the recessed surface 54 and within the sliding path of the shoulder 56. An attempt to slide the inhibitor 36 from the park position of FIGS. 3 and 5 toward the non-park position of FIGS. 4 and 6 brings the shoulder 56 into confronting engagement with the barrier member 38 and effectively blocks such sliding movement. As such, the system further acts to lock the shift lever 18 in the park position until such time as the key cylinder 20 is moved from the “off” position (FIGS. 3 and 5) to the “on” position (FIGS. 4 and 6) and the barrier member 38 is moved out of the path of the shoulder 56.

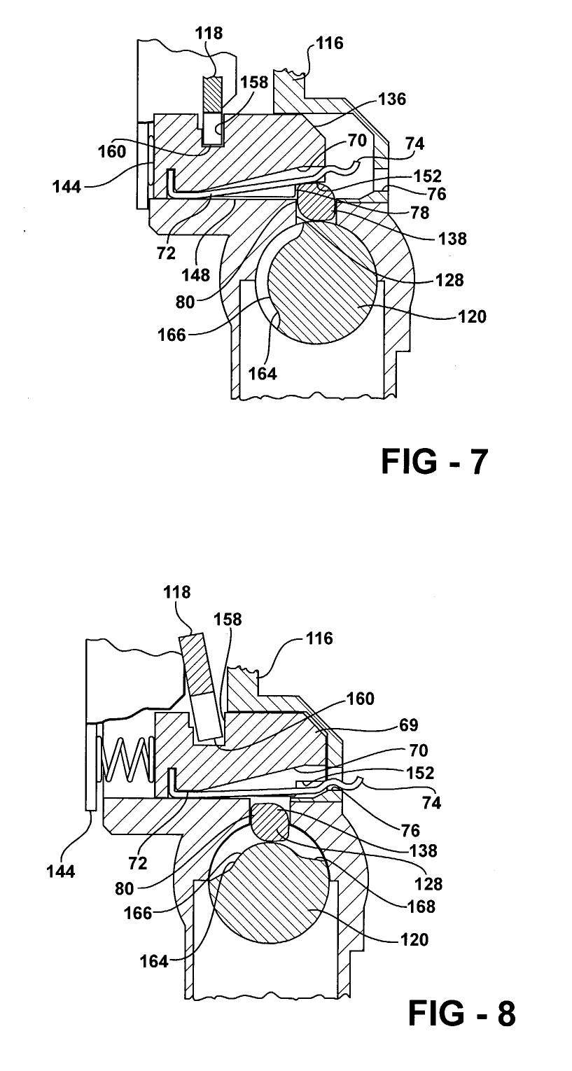

An alternate embodiment of the invention is shown in FIGS. 7 and 8. Like components are referenced by like reference numerals, but are offset by 100. An inhibitor 136 preferably has a spring channel 70 extending along at least a portion of its length with a leaf spring 72 maintained therein. The inhibitor 136 has a barrier pocket 152 for receiving a barrier member 138 extending between a lower surface 148 of the inhibitor 136 and the spring channel 70. The barrier pocket 152 has a shoulder or wall 78 generally perpendicular to the lower surface 148 for engaging a generally flat surface 80 of the barrier member 138 and the passage 128, respectively, when the key cylinder 120 is in the “off” position and the shift lever 118 is biased from the park position toward the non-park position. Since the wall 78 of the inhibitor 136 and the surface 80 of the barrier member 138 and the passage 128 are all oriented in a generally parallel relation to one another, the force generated between them substantially limits any forces from reacting toward the key cylinder 120.

The leaf spring 72 has a generally serpentine shaped end 74 for engagement with an opening 76 within a housing 116 (FIG. 8) when the inhibitor 136 is in the unlocked position. As in the first embodiment, a spring 144 may be incorporated to bias the inhibitor 136 toward the unlocked position, however, the leaf spring 72 maintains the inhibitor 136 in the unlocked position until a force from the shift lever 118 overcomes the force of engagement between the end 74 of the leaf spring 72 and the opening 76 in the housing 116.

When the key cylinder 120 is rotated from the “off” position toward the “on” position, the leaf spring 72 biases the barrier member 136 through the passage 128 and into the groove 164. As such, the inhibitor 136 is free to slide from the locked position to the unlocked position in response to pivotal movement of the shift lever 118.

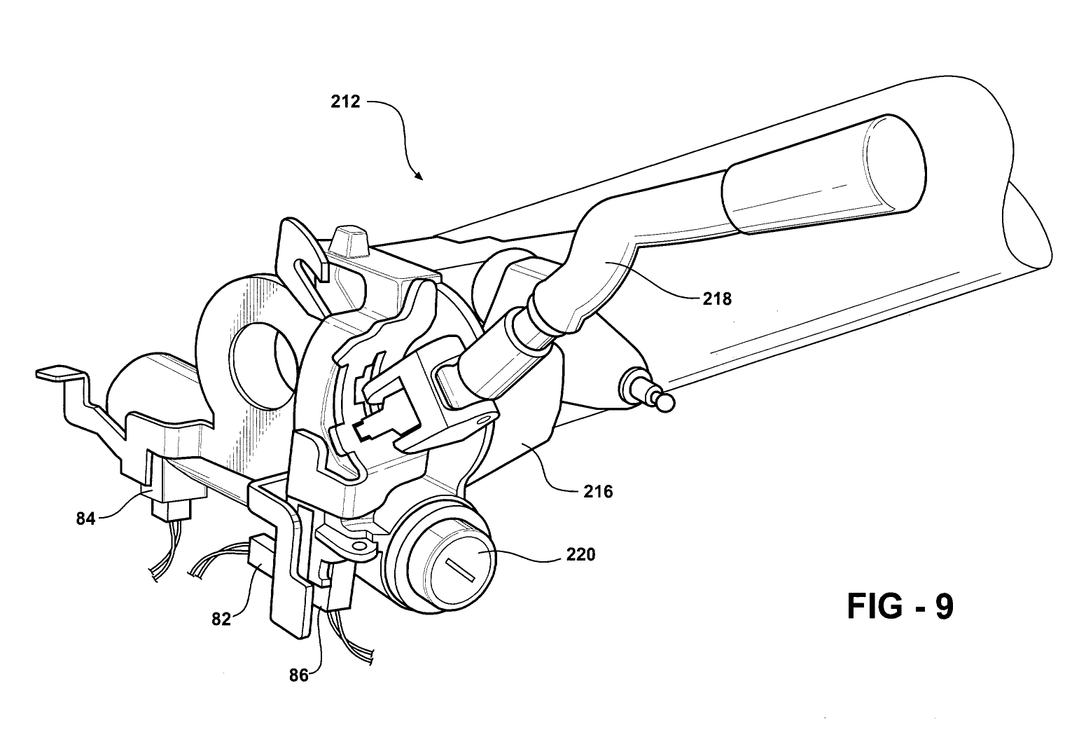

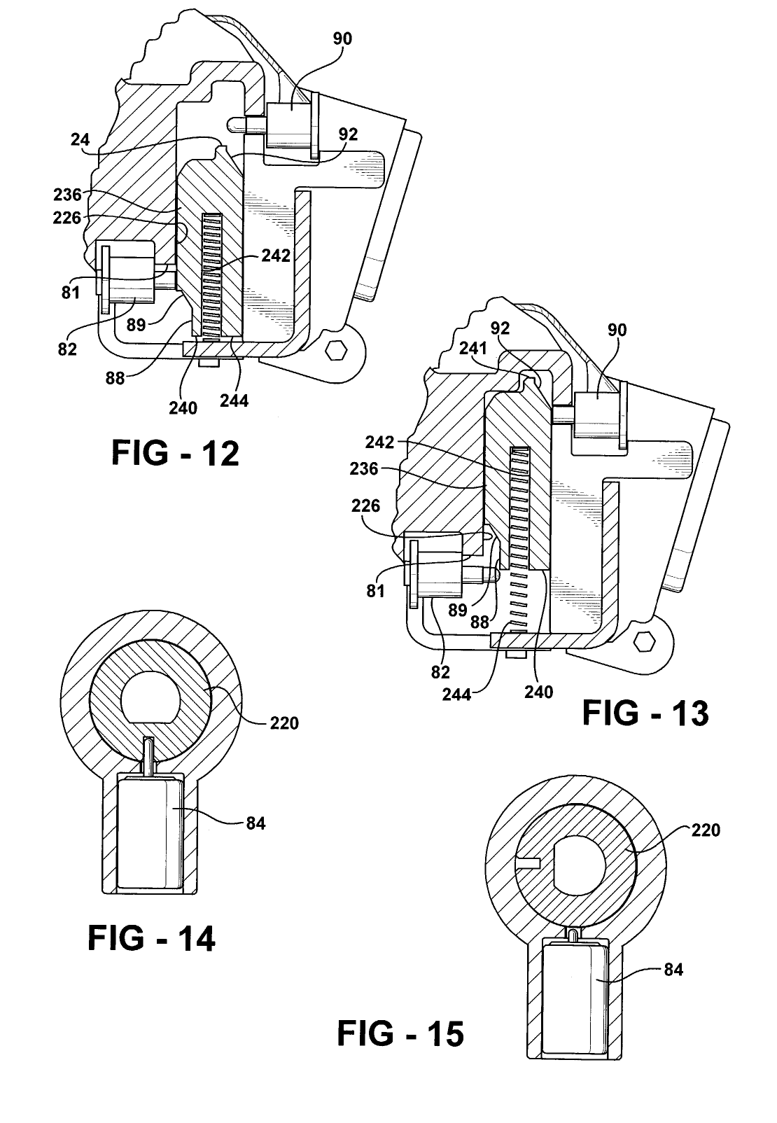

Another alternate embodiment of a steering column assembly of the present invention is shown generally at 212 in FIG. 9. Like reference numerals are used to designate like parts and features, but are offset by 200. The steering column assembly 212 has a housing 216 with an opening 81 for receiving a key cylinder switch 82 therein. The key cylinder switch 82 extends into a channel 226 so that when a shift lever 218 is in the parked position, an inhibitor 236 is in mating engagement with the switch 82, thereby depressing the switch 82 to an “off” position, as best shown in FIG. 12. As best shown in FIGS. 14 and 15, the key cylinder switch 82 is in operable connection with a key cylinder solenoid or actuator 84. With the key cylinder switch 82 depressed by the inhibitor 236, no power is provided to the key cylinder solenoid 82, thereby causing the key cylinder solenoid 82 to be disengaged or retracted from engaging a key cylinder 220 (FIG. 15). Therefore, the key cylinder 220 is free to rotate between the “off” position and the “on” position.

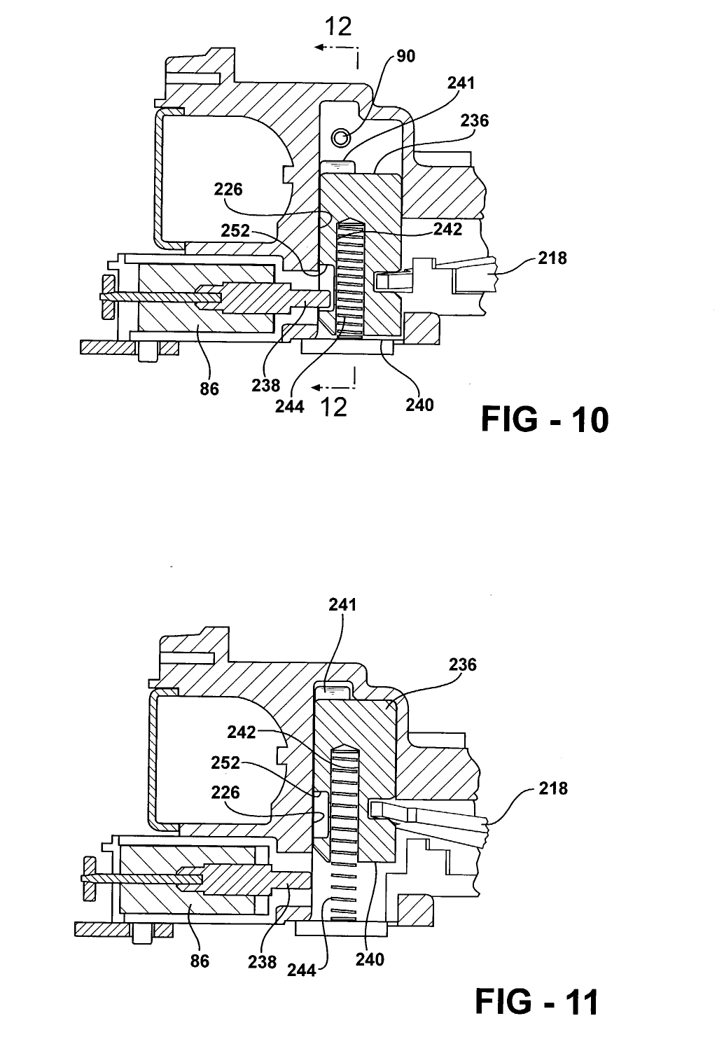

As best shown in FIGS. 10 and 11, an actuator or solenoid 86 has a plunger or barrier member 238 that extends into the channel 226 when the shift lever 218 is in the park position. The barrier member 238 is received within a barrier pocket 252 of the inhibitor 236, thereby preventing inadvertent or unintended movement of the shift lever 218 from the park position. The actuator 86 is in operable communication, preferably electrically, with the key cylinder switch 82 and a break pedal (not shown) of a vehicle. The actuator 86 is only activated, thereby retracting the barrier member 238 from the channel 226 and from the barrier pocket 252, upon an operator depressing the brake pedal and rotating the key cylinder 220 to the on position. When both the brake pedal is depressed and the key cylinder 220 is rotated to the “on” position, the barrier member 238 is removed from the barrier pocket 252 and the operator is free to move the shift lever 218 from the park position to the non-park position, as shown in FIGS. 11 and 13. With the shift lever 218 in the non-park position, the inhibitor 236 is moved to the unlocked position, thereby disengaging the inhibitor 236 from the key cylinder switch 82. To facilitate disengagement of the inhibitor 236 from the key cylinder switch 82, preferably a recess 88 is formed adjacent an end 240 of the inhibitor 236. The recess 88 preferably has a chamfered surface 89 to facilitate smooth engagement with the inhibitor 236 with the key cylinder switch 82 upon return of the inhibitor 236 to the locked position. With the key cylinder switch 82 disengaged from the inhibitor 236, the switch 82 extends into the channel 226, and in turn completes a circuit for power to reach the key cylinder solenoid 84. With the key cylinder solenoid 84 receiving power, the solenoid 84 extends into engagement with the key cylinder 220, as shown in FIG. 15, thereby preventing unintended rotation of the key cylinder 220 from the “on” position toward the “off” position while the vehicle is in the non-park position.

When the shift lever 218 is in the non-park position, the inhibitor 236 engages an inhibitor switch 90. The inhibitor switch 90 is in operable communication, preferably electrically, with the actuator 86 so that when the switch 90 extends in to the channel 226, the actuator 86 can receive power so that it will actuate upon depressing the brake pedal and turning the key cylinder 220 to the “on” position simultaneously. However, when the inhibitor switch 90 is engaged and fully depressed by the inhibitor 236 (FIG. 13), power can no longer reach the actuator 86, thereby preventing the actuator from actuating when the shift lever 218 is in the non-park position. This prevents the actuator 86 from actuating each time an operator depresses the brake when the vehicle is in the non-park position. To facilitate engagement of the inhibitor 236 with the inhibitor switch 90 while the shift lever 218 is returning to the park position, preferably the inhibitor 236 has a chamfered surface 92 adjacent an end 241 of the inhibitor 236. As in the first embodiment, the inhibitor 236 has a spring pocket 242 and a spring 244 received therein to prevent unintentional movement of the inhibitor 236 from the unlocked position while the shift lever 118 is in the non-park position.

Obviously, many modifications and variation of the present invention are possible in light of the above teachings. It is, therefore, to be understood that within the scope of the appended claims, the invention may be practiced otherwise than as specifically described. The invention is defined by the claims.

1. A park lock mechanism for a steering column, comprising:
a key cylinder rotatable about an axis between an off position and an on position;
a shift lever moveable between a park position and a non-park position; and
an inhibitor free from any mechanical cable attachment having a locked and an unlocked position operably communicating with said key cylinder so that when said key cylinder is in said off position, said inhibitor is operably maintained in said locked position preventing movement of said shift lever from said park position and when said key cylinder is in said on position, said inhibitor is moveable to said unlocked position in response to movement of said shift lever from said park position to said non-park position.

2. The park lock mechanism of claim 1 further comprising a barrier member moveable within a path between said key cylinder and said inhibitor so that when said key cylinder is in said off position, said barrier member obstructs movement of said inhibitor from said locked position, and when said key cylinder is in said on position, said barrier member is removed from obstructing said inhibitor allowing said inhibitor to move to said unlocked position.

3. The park lock mechanism of claim 2 wherein said inhibitor has a lower surface and a barrier pocket extending inwardly from said lower surface with said barrier pocket aligning with said barrier member to receive said barrier member when said key cylinder is in said off position and said barrier pocket being misaligned with said barrier member when said key cylinder is in said on position.

4. The park lock mechanism of claim 3 wherein said barrier pocket has a recessed surface and a shoulder extending between said recessed surface and said lower surface of said inhibitor with said shoulder engaging said barrier member when said key cylinder is in said off position and said shift lever is moved from said park position toward said non-park position to maintain said shift lever in said park position.

5. The park lock mechanism of claim 4 wherein said shoulder is inclined relative to said recessed surface.

6. The park lock mechanism of claim 4 wherein said shoulder is generally perpendicular to said recessed surface.

7. The park lock mechanism of claim 2 wherein said key cylinder has a groove for receiving said barrier member at least in part when said key cylinder is rotated to said on position.

8. The park lock mechanism of claim 7 wherein said key cylinder has an outer surface and said groove extends generally circumferentially at least in part about said outer surface.

9. The park lock mechanism of claim 8 wherein said groove has a base and an inclined surface extending between said outer surface and said base wherein said inclined surface engages said barrier member and biases said barrier member toward said inhibitor when said key cylinder is rotated from said on position toward said off position.

10. The park lock mechanism of claim 3 wherein said lower surface of said inhibitor prevents said barrier member from moving into said barrier pocket of said inhibitor when said key cylinder is in said on position and said shift lever is in said non-park position to prevent said key cylinder from moving into said off position.

11. The park lock mechanism of claim 3 further comprising a spring received at least in part within said barrier pocket acting to bias said barrier member toward said key cylinder.

12. The park lock mechanism of claim 1 further comprising a spring biasing said inhibitor toward said locked position.

13. The park lock mechanism of claim 12 wherein said inhibitor has a spring pocket in which said spring is received at least in part.

14. The park lock mechanism of claim 1 wherein said shift lever has a free end and said inhibitor has a slot releasably receiving said free end providing for mating engagement between said free end and said inhibitor during movement of said shift lever from said park position toward said non-park position and from said non-park position toward said park position.

15. The park lock mechanism of claim 2 wherein said key cylinder has an outer surface that defines a first distance between said outer surface and said inhibitor providing for interference between said barrier member and said inhibitor when said key cylinder is moved from said on position toward said off position and when said shift lever is in said non-park position to maintain said key cylinder in said on position.

16. The park lock mechanism of claim 15 wherein said key cylinder has a groove extending inwardly from said outer surface to a base, said base defining a second distance between said base and said inhibitor providing for clearance between said barrier member and said inhibitor when said key cylinder is in said on position.

17. The park lock mechanism of claim 1 wherein said key cylinder is free from any mechanical cable attachment.

18. A park lock mechanism for a steering column, comprising:
a housing having an opening and a channel extending generally transversely from said opening;
an actuator received at least in part in said opening and operable between off and on positions;
an inhibitor disposed in said channel and receiving a free end of a shift lever for slidable movement between locked and unlocked positions in response to pivotal movement of the shift lever from a park position to a non-park position, respectively, wherein said inhibitor is maintained in said locked position and substantially prevented from said slidable movement in said channel when said actuator is in said off position to prevent the shift lever from moving out of the park position and said inhibitor being slidably moveable from said locked position to said unlocked position when said actuator is in said on position to allow the shift lever to move from the park position to the non-park position.

19. The park lock mechanism of claim 18 wherein said actuator comprises a solenoid.

20. The park lock mechanism of claim 18 further comprising an inhibitor switch remaining in an extended position when said shift lever is in said park position allowing power to actuate said actuator to said on position when a brake is applied and a key cylinder is rotatated to an on position and said inhibitor switch being depressed when said shift lever is in said non-park position preventing power from actuating said actuator when the brake is applied.

21. The park lock mechanism of claim 20 wherein said inhibitor depresses said inhibitor switch when in said locked position and releases said inhibitor switch to said extended position when in said unlocked position.

22. The park lock mechanism of claim 21 wherein said inhibitor has a chamfered surface facilitating engagement with said inhibitor switch when said inhibitor is moving toward said unlocked position.

23. The park lock mechanism of claim 18 further comprising a key cylinder switch wherein said key cylinder switch remains depressed when the shift lever is in the park position allowing for rotation of a key cylinder and said key cylinder switch being in an extended position when the shift lever is in a non-park position preventing rotation of the key cylinder.

24. The park lock mechanism of claim 23 wherein said inhibitor depresses said key cylinder switch when in said unlocked position and releases said key cylinder switch to said extended position when in said locked position.

25. The park lock mechanism of claim 24 wherein said inhibitor has a chamfered surface facilitating engagement with said key cylinder switch when said inhibitor is moving toward said unlocked position.

26. The park lock mechanism of claim 18 further comprising a spring biasing said inhibitor toward said locked position.
